(19) United States
(12) Patent Application Publication
(10) Pub. No.: US 2026/0275061 A1
(43) Pub. Date: Sep. 17, 2026

(54) Composite Fiber-reinforced Resin and Shock Absorber

(71) Applicant: KOWA COMPANY, LTD., Nagoya-shi, Aichi (JP)

(72) Inventors: Hiroshi ODA, Tsukuba-shi, Ibaraki (JP); Daisuke NITTA, Komaki-shi, Aichi (JP); Hidetomo SAKIYAMA, Komaki-shi, Aichi (JP)

(73) Assignee: KOWA COMPANY, LTD., Nagoya-shi, Aichi (JP)

(21) Appl. No.: 19/469,768

(22) PCT Filed: Mar. 25, 2024
(86) PCT No.: PCT/JP2024/011600

§ 371 Date: Sep. 26, 2025

(30) Foreign Application Priority Data
Mar. 27, 2023 (JP) 2023-050047

(51) Int. Cl. C08J 5/24; B32B 5/02; B32B 5/26; B32B 7/03

(52) U.S. Cl. CPC C08J 5/247; B32B 5/022; B32B 5/266; B32B 7/03; C08J 5/245; B32B 2250/04; B32B 2260/023; B32B 2260/046; B32B 2262/106; C08J 2363/00

(57) ABSTRACT

A composite fiber-reinforced resin maintaining high strength and elasticity of a fiber-reinforced composite material, and having excellent impact resistance is provided herein. The composite fiber-reinforced resin has a plurality of layers of fiber-reinforced composite material layer and fiber layer, wherein the fiber-reinforced composite material layers are laminated such that adjacent layers have different fiber directions, and the fiber layer is arranged between at least one of the laminated fiber-reinforced composite material layers.

### TECHNICAL FIELD

The present invention relates to a composite fiber-reinforced resin and a shock absorber comprising the same.

### BACKGROUND ARTS

A fiber-reinforced composite material, which is made by combining a base material with reinforced fibers such as carbon fiber reinforced plastic (CFRP), is a material with light weight, high strength, and elasticity. Such properties are largely based on the mechanical properties of reinforced fibers such as carbon fiber, glass fiber, aramid fiber, and the like. In particular, it is known that carbon fiber has a mechanical property about 10 times greater than that of iron in terms of the specific strength (strength divided by the mass of the material) (Non-patent literature 1). Due to such mechanical properties and the chemical property of not rusting, the fiber-reinforced composite material is used as an alternative to metal in a variety of fields, including sport and leisure good, automobile, building, and aircraft.

On the other hand, CFRP is molded by laminating reinforced fibers such as carbon fiber and the like, therefore, there are no fibers in the thickness direction, and it has poor impact resistance (Non-patent literatures 2 and 3). Therefore, there is a problem that damage such as peeling between layers, resin cracking, fiber breakage, and others occurs inside the CFRP due to impact, and buckling or compression failure occurs easily when bending load or compressive load is applied to the damaged site.

Patent literature 1 discloses a method for solving the above problem of CFRP by attaching sheets of aromatic polyamide fiber-reinforced resin, which is a shock absorbency material, to both sides of a CFRP sheet so that the direction of the aramid fiber is inclined at ±30 to ±60 degrees with respect to the impact load direction, thereby improving impact resistance.

Patent literature 2 also discloses a composite material that solves the problem of poor compatibility of carbon fiber with other bonding materials in a method of imparting shock absorption to CFRP by adhering elastic polymers such as rubber and the like to a carbon fiber fabric, by coating the strands of the carbon fiber fabric with a sizing agent followed by melting the sizing agent through heat treatment, thereby impregnating the inside of the strands of the carbon fiber fabric with the sizing agent and achieving bonding to elastic polymers such as rubber and the like.

As mentioned above, conventional CFRP compensates for the low impact resistance of carbon fiber by adhering a shock absorbency material to the surface of the carbon fiber. However, as mentioned above, due to poor compatibility of carbon fiber with other bonding materials, so when using conventional bonding methods with adhesives and others, interface failure occurs at the bonding surface with the shock absorbency material. In addition, the method of Patent Literature 2 to solve this problem involves a large number of steps, which leads to new problems, such as increased manufacturing costs and prolonged manufacturing times.

### PRIOR ART DOCUMENTS

### Patent Literatures

[Patent literature 1] JP H8-197668 A
[Patent literature 2] JP Patent No. 6531245

### Non-Patent Literatures

[Non-patent literature 1] Toru Hiramatsu, An easy-to-understand introduction to carbon fiber composites, Nikkan Kogyo Shimbun, 2015, Chapter 1.
[Non-patent literature 2] Kaoru Hasumi et al., Development of plastic composite materials for sustainable recycling society, Chiba Industrial Technology Research Institute, Research Library (2010); https://www.pref.chiba.lg.jp/sanken/kenkyuu/library/h22/h22 library.html
[Non-patent literature 3] Masaru Kato, Keiichi Kutsuzawa, 2012, Tohoku Bureau of Economy, Trade and Industry, Next-generation manufacturing-base processing technology survey project in 2012, Cutting processing technology of composite materials (CFRP) and heat-resistant alloys, 41-51

### SUMMARY OF THE INVENTION

### Technical Problem

An object of the present invention is to provide a composite fiber-reinforced resin that maintains the high strength and elasticity of fiber-reinforced composite material and has excellent impact resistance.

### Solution to Problem

In order to solve the above problems, the present inventors have conducted extensive research and succeeded in developing a composite fiber-reinforced resin that has improved shock absorption while maintaining light weight and high strength and elasticity compared to conventional fiber-reinforced composite materials and a method for producing the same. The composite fiber-reinforced resin of the present invention has a fiber sheet comprising natural fibers inserted in at least one of the spaces between three or more-laminated fiber-reinforced composite material sheets such as CFRP and the like, and are constituted so that the fiber directions of the adjacent laminated fiber-reinforced composite materials are different from each other. As a result, the composite fiber-reinforced resin of the present invention can obtain an improved shock absorption effect while maintaining high strength and elasticity. The present invention is based on the results of the development and provides the following.

(1) A composite fiber-reinforced resin comprising fiber-reinforced composite material layers consisting of a fiber-reinforced composite material having a certain fiber direction, and a fiber layer consisting of a fiber sheet comprising natural fibers,
wherein the fiber-reinforced composite material layers consist of at least three layers, and are laminated so that the fiber-reinforced composite materials constituting adjacent fiber-reinforced composite material layers have fiber directions different from each other, and
wherein the fiber layer is arranged between at least one of the laminated fiber-reinforced composite material layers.

(2) The composite fiber-reinforced resin according to (1), wherein the fiber directions of the fiber-reinforced composite materials constituting adjacent fiber-reinforced composite material layers intersect at an angle of 50 degrees to 90 degrees.

(3) The composite fiber-reinforced resin according to (1) or (2), wherein the fiber-reinforced composite material layer comprises the fiber-reinforced composite material having two or more certain fiber directions.

(4) The composite fiber-reinforced resin any one of (1) to (3), wherein the fiber-reinforced composite material layer is four layers.

(5) The composite fiber-reinforced resin according to any one of (1) to (4), wherein the fiber layer is arranged between two or more of the fiber-reinforced composite material layers.

(6) The composite fiber-reinforced resin according to (5), wherein the fiber layer consists of a plurality of the same and/or different fiber sheets.

(7) The composite fiber-reinforced resin according to any one of (1) to (6), wherein the fiber sheet is a non-woven fabric.

(8) The composite fiber-reinforced resin according to any one of (1) to (7), wherein the natural fiber consists of cellulosic fiber and/or keratin-derived fiber.

(9) The composite fiber-reinforced resin according to any one of (1) to (8), wherein the fiber-reinforced composite material is a carbon fiber reinforced plastic (CFRP) prepreg.

(10) The composite fiber-reinforced resin according to any one of (1) to (9), which is a three-dimensional structure.

(11) A shock absorber comprising the composite fiber-reinforced resin according to any of (1) to (10).

The present specification encompasses the contents disclosed in Japanese Patent Application No. 2023-050047 on which the priority of the present application is based.

### Effects of the Invention

The composite fiber-reinforced resin of the present invention can provide a composite fiber-reinforced resin that maintains the high strength and elasticity of the fiber-reinforced composite material and has excellent impact resistance.

### BRIEF DESCRIPTION OF THE DRAWINGS

FIG. 1 shows a schematic diagram of the composite fiber-reinforced resin of the present invention. FIG. 1A shows an example of the layer constitution of the composite fiber-reinforced resin of the present invention described in Example 1. In this figure, the double-headed arrows on the layers (fiber-reinforced composite material layers) represented by 0101, 0103, 0104, and 0106 indicate the fiber direction of each layer. Also, in this figure, 0102 and 0105 indicate fiber layers. FIG. 1B is a figure showing the real angle (fiber crossing angle) at which the fiber directions (double-headed arrows) of adjacent fiber-reinforced composite material layers intersect.

FIG. 2 shows the test force-stroke graph of the composite fiber-reinforced resin of the present invention and others by puncture impact testing. In this figure, A indicates a composite fiber-reinforced resin consisting of CFRP-90/cupra, B indicates a composite fiber-reinforced resin consisting of CFRP-90/pulp, C indicates a composite fiber-reinforced resin consisting of CFRP-90/Japanese paper, D indicates a CFRP consisting of CFRP-90 only, E indicates a composite fiber-reinforced resin consisting of CFRP-0/pulp, and F indicates a laminate of pulp.

FIG. 3 shows an enlarged view of the range of stroke of 1.6 mm to 2.0 mm in FIG. 2. The formula in this figure represents the formula of the linear approximation curve of each graph. R² indicates the multiple correlation coefficient.

FIG. 4 shows another schematic diagram of the composite fiber-reinforced resin of the present invention. FIG. 4A shows an example of the layer constitution of the composite fiber-reinforced resin of the present invention described in Example 2. In this figure, the double-headed arrows on the layers (fiber-reinforced composite material layers) indicated by 0401, 0403, 0404, and 0406 represent the fiber direction of each of the layers. Also, in this figure, 0402 and 0405 indicate fiber layers. FIG. 4B is a diagram showing the real angle (fiber crossing angle) at which the fiber directions (double-headed arrows) of adjacent fiber-reinforced composite material layers intersect.

FIG. 5 shows the test force-stroke graph of the composite fiber-reinforced resin consisting of CFRP/pulp of the present invention (A) and the control test specimen consisting of CFRP only (B) by puncture impact testing.

FIG. 6 shows an enlarged view of range of stroke of 1.0 mm to 1.23 mm in FIG. 5. The formulae in this figure represent the formulae of the linear approximation curves of each graph. R² indicates the multiple correlation coefficient.

### DESCRIPTION OF THE EMBODIMENTS

### 1. Composite Fiber-Reinforced Resin

### 1-1. Overview

The first aspect of the present invention is a composite fiber-reinforced resin. The composite fiber-reinforced resin of the present invention is characterized by comprising a plurality of layers of fiber-reinforced composite material layers and fiber layers, wherein the fiber-reinforced composite material layers are laminated so that adjacent layers have different fiber directions, and wherein the fiber layers are arranged at at least one of the spaces between the laminated fiber-reinforced composite material layers.

According to the composite fiber-reinforced resin of the present invention, it is possible to improve the low impact resistance of the fiber-reinforced composite material, which has been a conventional problem, by having high shock absorption while maintaining the high strength and elasticity of the fiber-reinforced composite material.

### 1-2. Constitution

### 1-2-1. Composition Element

The term “composite fiber-reinforced resin” refers to a laminate constituted by laminating a plurality of fiber-reinforced composite materials. In the present specification, the term “lamination” refers to a state in which sheet-like materials having a planar structure are layered.

In the present specification, the term “laminate” refers to a structure constituted by laminating sheet-like materials.

In the present specification, the term “sheet-like material” refers to a material having a thin and flat structure. For example, sheet, cloth, film, paper, and membrane are included. The sheet-like material is usually soft and flexible, but it is not limited to in the present specification, and it may be rigid. The thickness of the sheet-like material is not limited. For example, a thickness of 1 μm or more, 2 μm or more, 3 μm or more, 4 μm or more, 5 μm or more, 6 μm or more, 7 μm or more, 8 μm or more, 9 μm or more, 10 μm or more, 15 μm or more, 20 μm or more, 30 μm or more, 40 μm or more, 50 μm or more, 60 μm or more, 70 μm or more, 80 μm or more, 90 μm or more, 100 μm or more, 150 μm or more, 200 μm or more, 250 μm or more, 300 μm or more, 350 μm or more, 400 μm or more, 450 μm or more, 500 μm or more, 5 mm or less, 4.5 mm or less, 4 mm or less, 3.5 mm or less, 3 mm or less, 2.5 mm or less, 2 mm or less, 1.5 mm or less, 1 mm or less can be used. Preferably, the thickness is 100 μm to 5 mm, 150 μm to 4.5 mm, 200 μm to 4 mm, 250 μm to 3.5 mm, 300 μm to 3 mm, 350 μm to 2.5 mm, 400 μm to 2 mm, 450 μm to 1.5 mm, or 500 μm to 1 mm.

The composite fiber-reinforced resin of the present invention is characterized in that it comprises the fiber layer, of which the sheet-like material is the fiber sheet, as an essential composition element, in addition to the fiber-reinforced composite material layer, of which the sheet-like material is the fiber-reinforced composite material.

The composite fiber-reinforced resin of the present invention may include layers other than the fiber-reinforced composite material layer and the fiber layer (for example, metal foil and the like) on the surface of the laminate and/or between the layers.

In the composite fiber-reinforced resin of the present invention, the sheet-like materials constituting the layers in principle completely contact with each other. However, there may be non-sites between some layers. Furthermore, the contacting areas between the layers may be either adhered or not adhered. Preferably, all of the layers constituting the composite fiber-reinforced resin are completely adhered to each other.

Hereinafter, each composition element of the composite fiber-reinforced resin of the present invention is explained.

### (1) Fiber-Reinforced Composite Material Layer

In the present specification, the term “fiber-reinforced composite material layer” refers to a layer constituted by the fiber-reinforced composite material.

The term “fiber-reinforced composite material” refers to a material in which two or more different materials, i.e., reinforced fiber and matrix (base material), are integrated in a separate state without being fused to each other. It includes, for example, carbon fiber reinforced plastic (often referred to as “CFRP” in the present specification), glass fiber reinforced plastic (often referred to as “GFRP” in the present specification), and aramid fiber reinforced plastic (often referred to as “AFRP” in the present specification) in which resin is impregnated into the reinforced fiber. In the present specification, the term “fiber-reinforced composite material” particularly means prepregs thereof and the like. Specifically, it includes CFRP prepreg, GFRP prepreg, and AFRP prepreg.

The fiber-reinforced composite material in the present specification has a structure that can be laminated. The fiber-reinforced composite material corresponds to the sheet-like material that constitutes the composite fiber-reinforced resin of the present specification.

The ratio of reinforced fiber to matrix in the fiber-reinforced composite material of the present specification is not particularly limited, and may be any ratio in well-known fiber-reinforced composite materials. In general, the ratio of reinforced fiber to matrix may be 1:0.005 to 1:1, 1:0.01 to 1:0.8, 1:0.02 to 1:0.6, 1:0.025 to 1:0.4, 1:0.03 to 1:0.2, 1:0.035 to 1:0.15, 1:0.04 to 1:0.1, 1:0.045 to 1:0.09, 1:0.05 to 1:0.08, and 1:0.055 to 1:0.07.

The constitution of reinforced fibers and matrix that constitute the fiber-reinforced composite material is explained below.

### (A) Reinforced Fiber

In the present specification, the term “reinforced fiber” refers to a fibrous substrate of the fiber-reinforced composite material. In general, the reinforced fiber refers to a reinforcing material that adds strength to a fiber-reinforced composite material. The reinforced fiber may be inorganic fiber, organic fiber or combination thereof.

Inorganic fiber includes carbon fiber, glass fiber, metal fiber (stainless steel, titanium, copper, aluminum, nickel, iron, tungsten, molybdenum and others), and amorphous fiber (ceramic fiber, rockwool, basalt fiber and others). For example, in the above-mentioned CFRP prepreg, carbon fiber is the reinforced fiber, and in the GFRP prepreg, glass fiber is the reinforced fiber. Organic fiber generally includes synthetic fiber such as aramid, polyamide (including nylon), polyester, polyethylene, acrylic and others. For example, in the above-mentioned AFRP prepreg, aramid fiber is the reinforced fiber. Natural fibers such as plant fiber, animal fiber, and recycled fiber and others may also be used.

The reinforced fiber may be constituted of a combination of a plurality of different fibers. In this case, a synergistic effect can be expected by combining reinforced fibers with different physical properties.

The fiber-reinforced composite material constituting the fiber-reinforced composite material layer of the present invention has a certain fiber direction. The term “fiber direction” as used herein refers to the orientation of the reinforced fibers comprised in the fiber-reinforced composite material, in principle, in the long axes direction. The phrase “have a certain fiber direction” means that the fiber bundles of the reinforced fibers have a certain orientation. The orientation of the reinforced fibers is not limited. A plurality of reinforced fibers may be arranged in one direction, or in two or more directions.

An example of arranging reinforced fibers in one direction in a fiber-reinforced composite material is UD material (one-directional material) in which the reinforced fibers are aligned in a straight line to form a plane arrangement.

Examples of arranging reinforced fibers in two directions include textiles such as fabric and braid, and filament winding arrangements described below. Fabric is a plane (sheet) formed by crossing warps and woofs. Specific examples of fabric include plain weave, twill weave, and satin weave, but the arrangement of reinforced fibers in the fiber-reinforced composite material may be any of them. In addition, the warps and woofs cross each other at a specific crossing angle. Furthermore, in filament winding, two reinforced fibers are wound around a mandrel at a specific crossing angle. These crossing angles are not particularly limited in the present specification. For example, the crossing angle on the acute angle side of the real angle may be 20 degrees to 90 degrees, 30 degrees to 85 degrees, 32 degrees to 80 degrees, 35 degrees to 78 degrees, 38 degrees to 75 degrees, 40 degrees to 70 degrees, 42 degrees to 68 degrees, 45 degrees to 65 degrees, 48 degrees to 60 degrees, 45 degrees to 58 degrees, or 50 degrees to 55 degrees.

### (B) Matrix

In the present specification, the term “matrix” refers to a supporting substrate in the fiber-reinforced composite material. Without limitation, the base material in the fiber-reinforced composite material is typically a polymeric matrix, the term “polymeric matrix” comprises organic polymers, inorganic polymers, or both. Organic polymers comprise synthetic and natural polymers.

In the present specification, the term “synthetic polymer” is a polymer obtained by linking monomers through condensation polymerization reactions or addition polymerization reactions. For example, synthetic resin synthetic rubber, and the like apply to them.

The term “synthetic resin” refers to an artificially produced polymeric compound that does not have rubber elasticity. It is a compound called plastic, and includes thermosetting resin, thermoplastic resin, or a combination thereof. It is noted that, strictly speaking, plastic refers to thermoplastic resin, but in the present specification, it is used in a broad sense as another name of synthetic resin. Specific examples of thermosetting resin include, but are not limited to, epoxy resin, unsaturated polyester resin, vinyl ester resin, phenolic resin, thermosetting polyurethane, urea resin, melanin resin, polyimide, silicon resin, and others. Specific examples of thermoplastic resin include, but are not limited to, polyethylene, polypropylene, polyester, polystyrene, polyvinyl chloride, methacrylic resin, fluorine resin, polycarbonate, thermoplastic polyurethane, aromatic polyether ketone resin, polyphenylene sulfide resin, polyoxymethylene, acrylonitrile, polybutylene, polyamide, polyacetal, polyvinyl alcohol, polyglycol, polyethylene terephthalate, polyethylene succinate, polybutylene adipate, polybutylene adipate terephthalate, polybutylene succinate, polylactic acid, polyhydroxyalkanoate, polyhydroxybutyric acid and others.

The term “synthetic rubber” refers to an artificially produced polymeric compound having rubber elasticity. It is a compound called elastomer, and comprises thermosetting elastomer, thermoplastic elastomer, or a combination thereof. Specific examples of thermosetting elastomer include, but are not limited to, butadiene rubber, chloroprene rubber, styrene butadiene rubber, isoprene rubber, ethylene propylene rubber, nitrile rubber, silicone rubber, acrylic rubber, fluororubber, urethane rubber and others.

In the present specification, the term “natural polymer” is a polymer that exists in nature, for example, protein, polysaccharide, and natural resin. Specific examples of natural polymer consisting of proteins include glue (comprising collagen and gelatin). Specific examples of natural polymer consisting of polysaccharides include starch, cellulose, mannan, and agar. Furthermore, specific examples of natural polymer consisting of natural resins include lacquer, rosin, latex (natural rubber), shellac and others.

In the present specification, the manufacturing method of the fiber-reinforced composite material is not particularly limited, and it may be manufactured by any existing method. For example, it includes press molding, in which matrix and reinforced fiber are placed in a preheated mold and cured while pressurizing with a press machine; internal pressure molding, in which compressed air is injected into the interior of an object to be molded to mold it; pultrusion molding, in which reinforced fiber impregnated with liquid matrix is drawn into a mold and cured by heat; filament winding, in which reinforced fiber impregnated with liquid matrix is wound around a mandrel and then cured by heat; RTM molding (resin-transfer molding) (comprising vacuum assisted VaR™ molding), in which a preform made of pre-molded reinforced fibers is arranged in a mold consisting of male and female molds, and liquid matrix is pressed into it, and cured by heat after impregnating the fibers with the matrix; autoclaving, injection molding, sheet winding and the like.

### (2) Fiber Layer

In the present specification, the term “fiber layer” refers to a layer consisting of the fiber sheet in the composite fiber-reinforced resin of the present invention.

In the present specification, the term “fiber sheet” refers to a sheet-like constitution material in which a plurality of fiber bundles is arranged in a plane in one direction, or in two or more directions. The fiber sheet corresponds to the sheet-like material constituting the composite fiber-reinforced resin in the present specification. The fiber sheet may be constituted by natural fibers only, or may comprise natural fibers as the main component and contain other components, for example, synthetic fibers and the above-mentioned matrix. The natural fibers comprised in the fiber sheet may be derived from a single species or from a plurality of species.

In the present specification, the term “natural fiber” refers to a fibrous natural polymer produced by an organism, or an artificial fibrous polymer obtained by processing and spinning a material derived from an organism. Examples of natural fiber include, but are not limited to, cellulosic fiber and polypeptide fiber.

In the present specification, the term “cellulosic fiber” refers to a fibrous polymer of which the main component is cellulose, a polysaccharide. It is a fiber derived mainly from plant fibers, specifically, such as cotton, hemp, and paper. Paper includes Japanese paper, tissue paper (including Kimwipe (registered trademark)), and paper towel (including Kimtowel (registered trademark)). In addition, it includes recycled fiber such as rayon, tencel, lyocell, which are made from wood pulp, cupra and the like.

In the present specification, the term “polypeptide fiber” refers to a fibrous polymer of which the main component is a polypeptide constituting a protein. It is a fiber derived mainly from animal fiber and can be broadly divided into keratin-derived fiber and fibroin-derived fiber. The term “keratin-derived fiber” refers to a fibrous polypeptide of which main component is keratin protein. For example, it includes animal hair and feathers. Specifically, it includes wool, goat hair, llama hair, horse hair, camel hair, fox hair, raccoon hair, chinchilla hair, rabbit hairand the like. The term “fibroin-derived fiber” refers to a fibrous polypeptide of which main component is fibroin protein. For example, it includes natural animal fiber such as silk obtained from the larvae of moth such as silkworm moth (Bombyx mori), wild silkworm moth (B. mandarina), moths of the families Saturniidae or Psychidae, and the like, or bees, spider silk and the like.

The fiber sheet may consist of any of a woven or non-woven fabric. The non-woven fabric is more preferred without limitation.

The term “non-woven fabric” refers to a sheet-like web oriented in one direction or randomly, in which the fibers are bonded by intertwining, fusion and/or adhesion to be cloth-like. In the present specification, paper is also considered a type of non-woven fabric.

In the present specification, the non-woven fabric may be manufactured by an existing method. Manufacturing of non-woven fabric includes, for example, dry laying, wet laying, spunbonding, melt blowing, thermal bonding, impregnated chemical bond method, spray chemical bond method, needlepunching, spunlace bonding, composite methods thereof, and others. Depending on the properties of the fibers constituting each of the layers and/or the fiber length, it may be appropriately determined which method to use for manufacturing. For example, for a nonwoven fabric consisting of synthetic fibers, the following methods can be used: impregnated chemical bond method and splay chemical bond method, in which synthetic resin is used as an adhesive for chemical adhering of the fibers; thermal bonding, in which the fibers are fused by heating; melt blowning, in which thin fibers having thickness of 1 d to 10 d are spined with high-temperature air which let melted resin to be blown from around a spinning nozzle and simultaneously laminated; spunlace bonding, in which high-pressure water is sprayed onto webs to entangle the fibers.

### 1-2-2. Structure

The structure of the composite fiber-reinforced resin of the present invention is described below.

The shape of the composite fiber-reinforced resin of the present invention is not limited as long as it has a laminate structure that comprises the fiber-reinforced composite material layer and the fiber layer. For example, it may be a planar shape such as a plate or sheet-like shape, and it may be a three-dimensional shape that forms any three-dimensional structure. The three-dimensional structure can be formed by laminating on a mold surface during the forming process (manufacturing process), or it can be produced as a planar laminate followed by forming into a desired shape by plastic deformation.

The composite fiber-reinforced resin of the present invention is a laminate comprising the fiber-reinforced composite material layer and the fiber layer.

In the composite fiber-reinforced resin of the present invention, the number of laminated fiber-reinforced composite material layers is not particularly limited, but may be, for example, 3 layers or more, 4 layers or more, 5 layers or more, 6 layers or more, 7 layers or more, 8 layers or more, 9 layers or more, 10 layers or more, 12 layers or more and 14 layers or more, as well as 100 layers or less, 80 layers or less, 60 layers or less, 50 layers or less, 40 layers or less, 30 layers or less, 20 layers or less, and 15 layers or less. Here, the types of fiber-reinforced composite material constituting the fiber-reinforced composite material layers may be the same type, different types, or a combination thereof. “The same type” as used herein means that all constitution conditions, including the type of reinforced fiber that constitutes the fiber-reinforced composite material (such as carbon fiber, glass fiber and aramid fiber), the direction of the reinforced fiber in the fiber-reinforced composite material (such as one direction arrangement and multidirectional arrangement), the crossing angle of the reinforced fiber in the reinforced composite material in the case of a multidirectional arrangement, the type of matrix, and others, are the same. For example, this applies when all fiber-reinforced composite material layers are constituted by CFRP prepregs manufactured in the same lot. “Different types”, on the other hand, means that at least one of the above-mentioned constitution conditions is different. For example, the fiber-reinforced composite material layer may be constituted by a combination of CFRP prepreg and GFRP prepreg, or may be constituted by a combination of a CFRP prepreg of which the reinforced fiber has one fiber direction and a CFRP prepreg of which the reinforced fiber has two fiber directions produced by filament winding.

The composite fiber-reinforced resin of the present invention is characterized in that the fiber directions of the reinforced fibers in the fiber-reinforced composite material constituting the fiber-reinforced composite material layer are arranged so that they are different from each other in adjacent fiber-reinforced composite material layers.

In the present specification, the term “adjacent” means that two fiber-reinforced composite material layers are arranged to be adjacent in a laminate. This also includes adjacency in which the fiber-reinforced composite material layers directly contact each other, as well as cases in which other composition element, such as fiber sheets are inserted between two of the fiber-reinforced composite material layers.

In the present specification, the phrase “so that they have fiber directions different from each other” means that in the case of the fiber-reinforced composite material in which the reinforced fibers are arranged in one direction, such as UD material, the fiber directions of the reinforced fibers of the two fiber-reinforced composite material layers do not match. In addition, it also means that in the case of the fiber-reinforced composite material in which the reinforced fibers are arranged in two or more fiber directions, such as the fiber-reinforced composite material produced by filament winding, at least ones of the fiber directions of the reinforced fibers comprised by two of the fiber-reinforced composite material layers does not match.

Only two of the adjacent fiber-reinforced composite material layers are arranged so that their fiber directions are different from each other. Therefore, for example, when the composite fiber-reinforced resin of the present invention comprises three fiber-reinforced composite material layers, the fiber direction of the reinforced fiber of the fiber-reinforced composite material layer arranged in the center may be arranged in a direction different from the fiber directions of each of the layers arranged on both sides (front and back). On the other hand, the fiber directions of the fiber-reinforced composite material layers arranged on both sides (front and back) may be arranged to be the same, or different among all of the three layers.

As described above, the term “different fiber directions” may be any direction in which the fiber directions of adjacent fiber-reinforced composite material layers do not match each other, but it is preferable that the crossing angle (real angle) between the fibers on the acute angle side is 50 degrees to 90 degrees, 52 degrees to 88 degrees, 54 degrees to 85 degrees, 56 degrees to 80 degrees, 58 degrees to 78 degrees, 60 degrees to 75 degrees, 62 degrees to 70 degrees, or 64 degrees to 68 degrees.

The number of certain directions of the reinforced fibers comprised in the fiber-reinforced composite material of each of the fiber-reinforced composite material layers may be the same, different or a combination thereof. Without limitation, each of the fiber-reinforced composite material layers preferably has two or more fiber directions.

In the composite fiber-reinforced resin of the present invention, there may be 1 layer or more, 2 layers or more, 3 layers or more, 4 layers or more, 5 layers or more, 6 layers or more, 7 layers or more, 8 layers or more, 9 layers or more, 10 layers or more, 12 layers or more, and 14 layers or more, as well as 100 layers or less, 80 layers or less, 60 layers or less, 50 layers or less, 40 layers or less, 30 layers or less, 20 layers or less, and 15 layers or less of the fiber layer.

As a feature of the composite fiber-reinforced resin of the present invention, the fiber layer is arranged at least one of the spaces between the laminated fiber-reinforced composite material layers. As long as this condition is satisfied, other fiber layers may be arranged in any way. For example, one or more fiber layers may be arranged at all interlayer spaces between the fiber-reinforced composite material layers, or one or more fiber layers may be arranged at every 2 interlayer spaces, every 3 interlayer spaces, every 4 interlayer spaces, every 5 interlayer spaces between the fiber-reinforced composite material layers or a combination thereof. Alternatively, one or more fiber layers may be randomly arranged between the fiber-reinforced composite material layers. Furthermore, the fiber layer may be arranged at only one of the spaces between the fiber-reinforced composite material layers, and the other fiber layers may be arranged on one or both surfaces of the laminated fiber-reinforced composite material layers.

### 1-3. Uses

As shown in the examples below, compared to conventional composite fiber-reinforced resins such as CFRP, the composite fiber-reinforced resin of the present invention has high impact resistance as a new physical property not found in conventional composite fiber-reinforced resins while maintaining strength and elasticity. Therefore, by taking advantage of these physical properties, for example, it can be used as a substitute material in a known structure constituted of resin. Particularly, it is suitable for use as a substrate of a structure that is expected to receive a strong impact.

The composite fiber-reinforced resin of the present invention can be used as, but is not particularly limited to, structures of sporting gears including tennis or badminton rackets, golf shafts, snowboards, skis, ski poles, climbing poles and fishing rods, structures of bumpers, guards, fuel tanks, frames, rims, body panels, helmets and the like for moving objects including cars, motorcycles, bicycle frames, ships, aircraft and drones, structures or reinforcements of buildings and the like, structures of electronic product, or various housings.

### 2. Shock Absorber

### 2-1. Overview

A second aspect of the present invention is a shock absorber. The shock absorber of the present invention is characterized by comprising the composite fiber-reinforced resin of the first aspect.

The shock absorber of the present invention utilizes the high impact resistance of the composite fiber-reinforced resin of the first aspect in addition to the high strength and elasticity of conventional composite fiber-reinforced resin. The shock absorber of the present invention can be used as a material that imparts the physical properties and high impact resistance of conventional composite fiber-reinforced resin to structures or locus where conventional composite fiber-reinforced resin could not be used due to its low impact resistance.

### 2-2. Constitution

In the present specification, the term “shock absorption” refers to the property of absorbing the impact force that occurs when an object collides at a certain speed.

In the present specification, the term “shock absorber” refers to a material with a long stress generation time on the collided surface when an object collides with it. The shock absorber can reduce the maximum impact force upon the collision by converting the impact energy into other energy. Such energy may include, for example, deformation energy, vibration energy, heat energy.

The shock absorber of the present invention comprises the composite fiber-reinforced resin of the first aspect as a main structural component. The content rate of the composite fiber-reinforced resin of the first aspect in the shock absorber of the present invention is not particularly limited as long as it is within a range in which the impact resistance of the composite fiber-reinforced resin can be maintained and/or exhibited. The content rate may be, for example, 1 mass % or more, 2 mass % or more, 3 mass % or more, 4 mass % or more, 5 mass % or more, 8 mass % or more, 10 mass % or more, 15 mass % or more, 20 mass % or more, 25 mass % or more, 30 mass % or more, 35 mass % or more, 40 mass % or more, 45 mass % or more, 50 mass % or more, 55 mass % or more, 60 mass % or more, 65 mass % or more, 70 mass % or more, 75 mass % or more, 80 mass % or more, 85 mass % or more, 90 mass % or more, 92 mass % or more, 95 mass % or more, 96 mass % or more, 97 mass % or more, 98 mass % or more, 99 mass % or more, 100% by mass.

When the shock absorber of the present invention comprises other structural components, any type of structural components may be comprised. Preferably, the structural components may be those which do not reduce the impact resistance of the composite fiber-reinforced resin of the first aspect, and more preferably, structural components which can provide higher impact resistance by a synergy effect. For examples, they include polymer foam such as polyurethane foam and polystyrol (expanded polystyrene), glass wool, carbon wool, natural rubber, synthetic rubber, metal spring, organic polymer spring, hydrogel, and airbag. In the shock absorber of the present invention, the composite fiber-reinforced resin of the first aspect may directly or indirectly contact with the other structural components. In the case of direct contact, the two may be adhered to each other, or may be non-adhered and separable.

### EXAMPLES

### Example 1

### (Aim)

The shock absorption of the composite fiber-reinforced resin of the present invention and the maintenance of the strength and elasticity of the fiber-reinforced composite material are verified.

### (Material)

CFRP prepreg: PAN-based CF, Mass: 200 g/m², Thickness: 0.12 mm, CF mass: 150 g/m², Epoxy resin content: 25 wt %
Cupra: Asahi Kasei SN140 Bemliese; Mass: 13.5 g/m², Thickness: 0.07 mm
Pulp: Kimwipe by Nippon Paper Crecia; Mass: 22.5 g/m², Thickness: 0.18 mm
Japanese paper: Toyoda handmade Japanese paper; Mass: 28.1 g/m², Thickness: 0.13 mm

### Method

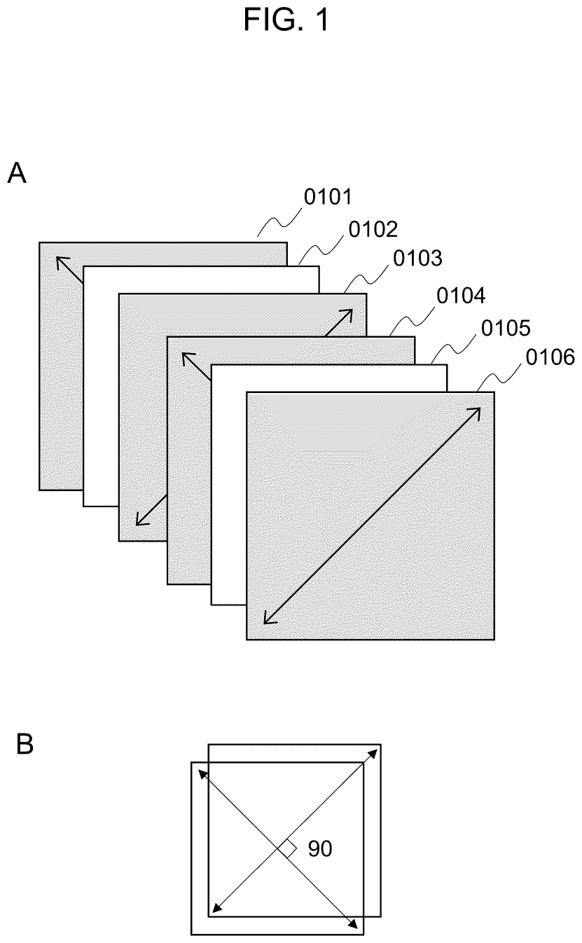

### (1) Constitution of Each Test Specimen (FIG. 1)

### (a) CFRP-90/Cupra (A)

Fiber-reinforced composite material layer: Four prepregs (FIG. 1A: 0101, 0103, 0104, 0106) were laminated so that the real angle (fiber crossing angle) at which the fiber directions of adjacent prepregs intersected was 90 degrees (FIG. 1B).
Fiber layer: Two sheets of cupra (FIG. 1A: 0102, 0105) were arranged one by one between two of the prepreg layers (FIG. 1A: between 0101 and 0103, 0104 and 0106).

### (b) CFRP-90/Pulp (B)

The basic constitution was in accordance with (a). However, the fiber layers were two sheets of pulp instead of cupra (FIG. 1A: 0102, 0105).

### (c) CFRP-90/Japanese Paper (C)

The basic constitution was in accordance with (a). However, the fiber layers were two sheets of Japanese paper instead of cupra (FIG. 1A: 0102, 0105).

### (d) CFRP-90 (Control: Fiber-Reinforced Composite Material Layer Only) (D)

It was constituted of only the fiber-reinforced composite material layer, in which four prepregs were laminated so that the fiber crossing angle of adjacent prepregs was 90 degrees. It consisted of the constitution of FIG. 1A without the fiber layers (0102, 0105).

### (e) CFRP-0/Pulp (E)

The basic constitution was in accordance with (b). However, it was constituted by laminating so that the adjacent fiber directions of the four prepregs that constituted the fiber-reinforced composite material layers were in the same direction without crossing, i.e., had the real angle of 0 degrees.

### (f) Laminate of Pulp (Control: Fiber Layer Only) (F)

It was constituted of only four laminated sheets of pulp.

### (2) Production of Composite Fiber-Reinforced Resin

For the test specimens (a) to (c), each was placed in a stainless steel mold (t=5 mm: 2 pieces) and pressurized at 100° C. for 10 minutes, at about 2.5 MPa in a high-temperature hot press machine (AS ONE: H400-05) to impregnate the epoxy resin into the fiber layer. (d) was also hot pressed in the same manner. Next, the epoxy resin was cured by keeping pressurized at 120° C. for 120 minutes at about 2.5 MPa. After curing, the mold was removed, and the specimens were slowly cooled to obtain test specimens with a thickness of about 0.5 mm. Next, the pressed test specimens (a) to (d) were cut into 60 mm² squares using an ultrasonic cutter (Sonotec: SF-3140| SF-3400II).

### (3) Puncture Impact Testing Conditions

The surface impact strength of each of the test specimens was measured by puncture impact testing using a puncture impact testing machine (Shimadzu Corporation: HITS-PX). Each of the test specimens prepared in (2) above was arranged on a test specimen support and fixed with a pressure plate. A striker with a diameter of 20 mm was collided perpendicularly with the center surface of the test specimen at room temperature (approximately 25° C.) at a loading speed of 10 m/sec. The displacement occurred from the striker's collision until the test force became 0 was measured.

### Results

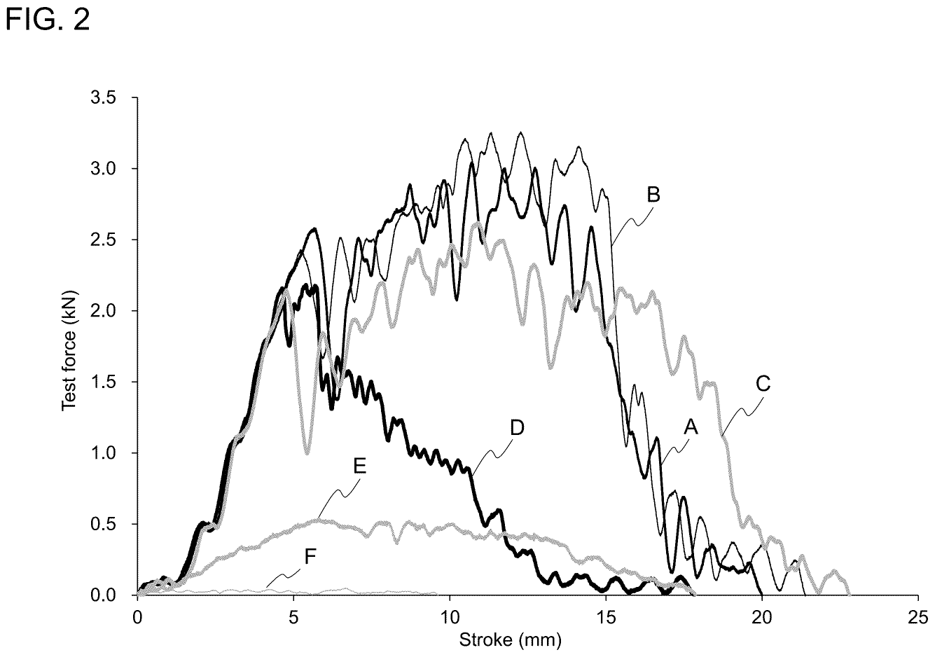

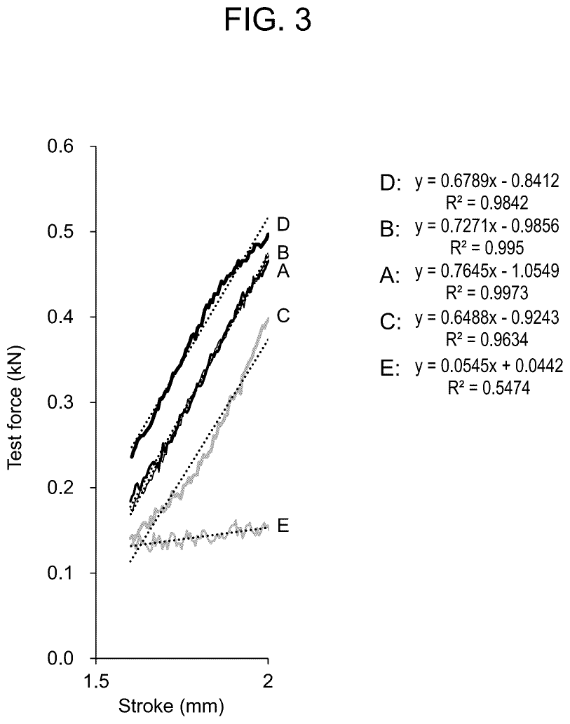

The results are shown in FIGS. 2 and 3, and in Table 1.

TABLE 1

| | A | B | C | D | E | F |
|---|---|---|---|---|---|---|
| constitution | CFRP-90/ | CFRP-90/ | CFRP-90/ | CFRP-90 | CFRP-0/ | pulp |
| | Cupra | pulp | Japanese | only | pulp | Laminate |
| | | | paper | | | only |
| Maximum | 3.043 | 3.258 | 2.620 | 2.184 | 0.535 | 0.050 |
| test force | | | | | | |
| (kN) | | | | | | |

FIG. 2 shows that the breaking points (maximum test force points) of CFRP-90/cupra (A), CFRP-90/pulp (B), and CFRP-90/Japanese paper (C), which have the constitution of the composite fiber-reinforced resin of the present invention, have clearly higher stroke values compared to the breaking points of the control CFRP-90 only (D), CFRP-0/pulp (E), which are differ from B in that all of the fiber directions of the reinforced fibers are the same, and the pulp laminate only (F). A result that the test specimens break at a high stroke indicates high shock absorption. Therefore, these results demonstrated that A to C, which have the constitution of the composite fiber-reinforced resin of the present invention, have shock absorption that D and E do not have.

FIG. 3 is an enlarged view of the range of stroke of 1.6 mm to 2.0 mm in FIG. 2. In the linear approximation curve formula (y=ax+b) shown in this figure, if the slope (a) in the low stroke range is used as an index of elasticity, A to C are almost the same as D. Also, as shown in Table 1, the maximum test force is A: 3.043 kN, B: 3.258 kN, C: 2.620 kN, and the maximum test force of A to C is higher than that of D (: 2.184 kN). This result indicates that A to C maintain the strength and elasticity of CFRP.

The above results demonstrate that A to C, the composite fiber-reinforced resins of the present invention, have high shock absorption as a new physical property, while maintaining the strength and elasticity of the fiber-reinforced composite material, which is their structural component.

### Example 2

### (Aim)

The effect of the present invention, in the case that the fiber crossing angle of adjacent fiber-reinforced composite material layers in the composite fiber-reinforced resin of the present invention is changed, is verified.

### (Material)

CFRP prepreg: PAN-based CF, Mass: 200 g/m², Thickness: 0.12 mm, CF mass: 150 g/m², Epoxy resin content: 25 wt %
Pulp: Kimwipe by Nippon Paper Crecia; Mass: 22.5 g/m², Thickness: 0.18 mm

### Method

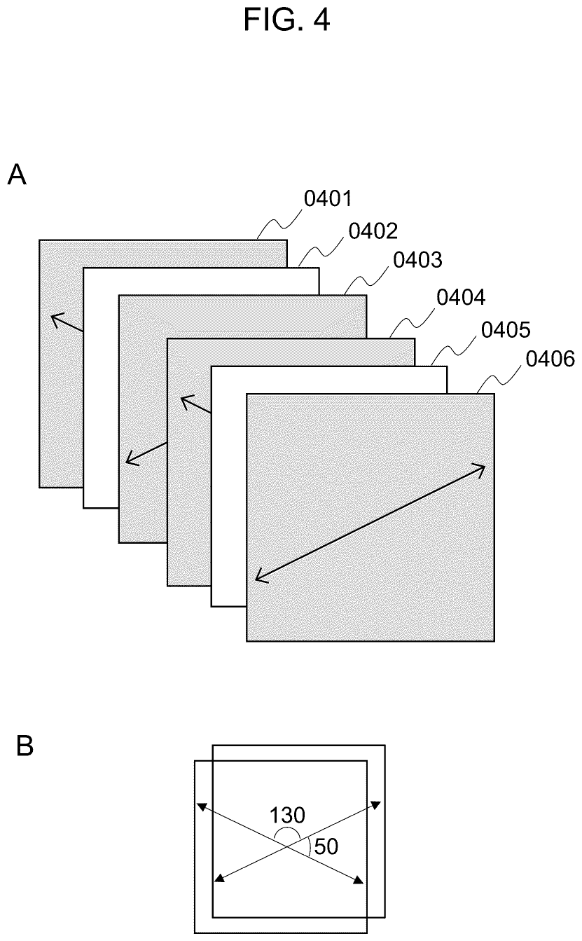

### (1) Constitution of Each Test Specimen (FIG. 4)

### (a) CFRP-50/Pulp (A)

Fiber-reinforced composite material layer: Four prepregs (FIG. 4A: 0401, 0403, 0404, 0406) were laminated so that the fiber crossing angle of adjacent prepregs was 50 degrees/130 degrees (FIG. 4B).
Fiber layer: Two sheets of pulp (FIG. 4A: 0402, 0405) were arranged one by one between two prepreg layers (FIG. 4A: between 0401 and 0403, between 0404 and 0406).

### (b) CFRP-50 (Control: Fiber-Reinforced Composite Material Layer Only) (B)

It was constituted of only the fiber-reinforced composite material layers, which were made by laminating four prepregs so that the fiber crossing angle of adjacent prepregs was 50 degrees/130 degrees. It consists of the constitution of FIG. 4A without the fiber layers (0402, 0405).

### (2) Production of Composite Fiber-Reinforced Resin

The basic method was as described in Example 1 (2).

### (3) Puncture Impact Testing Conditions

The basic method was as described in Example 1 (3).

### Results

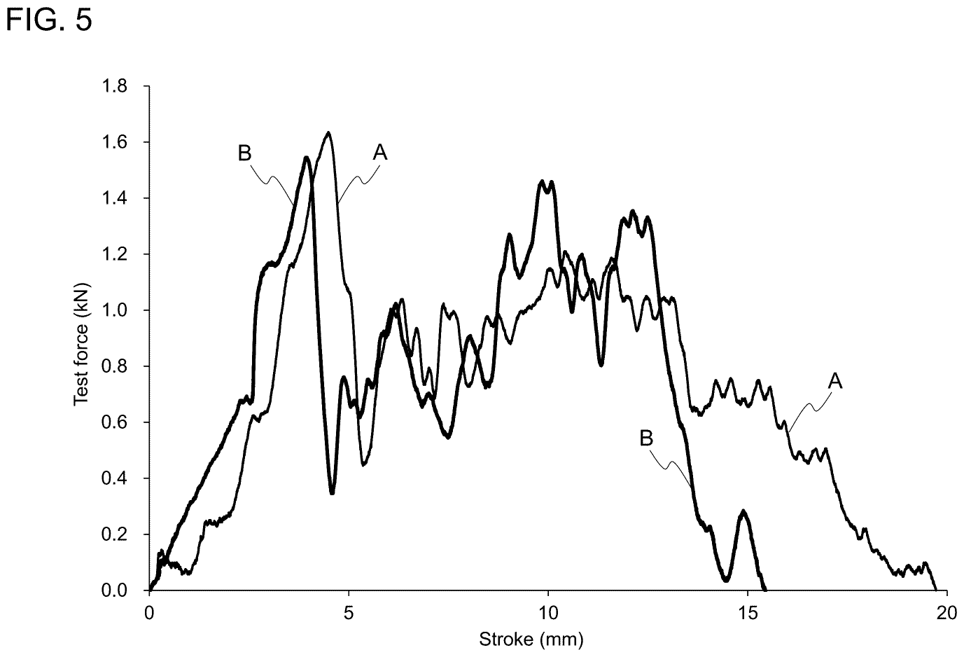

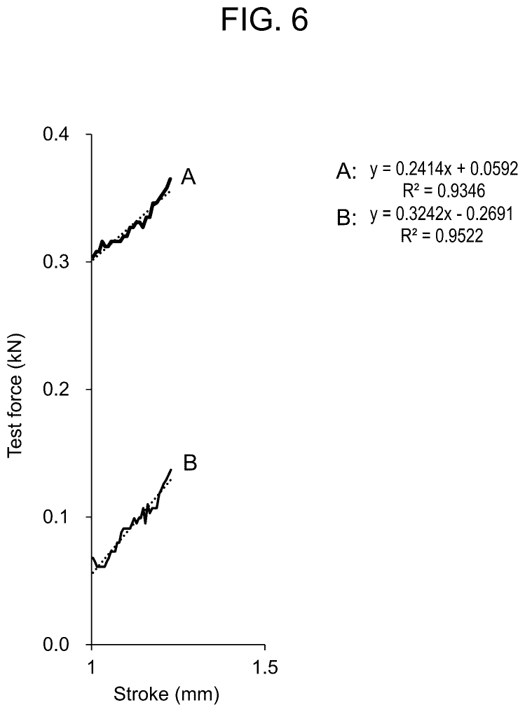

The results are shown in FIGS. 5 and 6, and Table 2.

TABLE 2

| | |
|---|---|
| A | B |

constitution

| | CFRP-50/ | CFRP-50 |
|---|---|---|
| | pulp | only |
| Maximum | 1.636 | 1.545 |
| test force | | |
| (kN) | | |

FIG. 5 shows that the breaking point of CFRP-50/pulp (A), having the constitution of the composite fiber-reinforced resin of the present invention, has a higher stroke value than the breaking point of CFRP-50 (B), similar to that in Example 1. This result indicates that the composite fiber-reinforced resin of the present invention has shock absorption that is not present in the laminate of CFRP-90 (D) or pulp (E), even when the fiber crossing angle of the adjacent fiber-reinforced composite materials is 25 degrees on the acute angle side.

FIG. 6 is an enlarged view of the range of stroke of 1.0 mm to 1.23 mm in FIG. 2. The slopes of A and B (R²) in the low stroke range are almost the same. Thus, it has been revealed that the strength and elasticity of the CFRP can be maintained, even when the fiber crossing angle of adjacent fiber-reinforced composite materials in the composite fiber-reinforced resin of the present invention is 50 degrees on the acute angle side. In addition, as shown in Table 2, the maximum test force is A: 1.636 kN, which is equal to or more than B: 1.545 kN. This result indicates that A also maintains the strength and elasticity of the CFRP.

All publications, patents, and patent applications cited in the specification are entirely incorporated by reference.

1. A composite fiber-reinforced resin comprising fiber-reinforced composite material layers consisting of a fiber-reinforced composite material having a certain fiber direction, and a fiber layer consisting of a fiber sheet comprising natural fibers,
wherein the fiber-reinforced composite material layers consist of at least three layers and are laminated so that the fiber-reinforced composite materials constituting adjacent fiber-reinforced composite material layers have fiber directions different from each other, and
wherein the fiber layer is arranged between at least one of the laminated fiber-reinforced composite material layers.

2. The composite fiber-reinforced resin according to claim 1, wherein the fiber directions of the fiber-reinforced composite materials constituting adjacent fiber-reinforced composite material layers intersect at angle of 50 degrees to 90 degrees.

3. The composite fiber-reinforced resin according to claim 1, wherein the fiber-reinforced composite material layer comprises the fiber-reinforced composite material having two or more certain fiber directions.

4. The composite fiber-reinforced resin according to claim 1, wherein the fiber-reinforced composite material layer is four layers.

5. The composite fiber-reinforced resin according to claim 1, wherein the fiber layer is arranged between two or more layers of the fiber-reinforced composite material layers.

6. The composite fiber-reinforced resin according to claim 5, wherein the fiber layer consists of a plurality of the same and/or different fiber sheets.

7. The composite fiber-reinforced resin according to claim 1, wherein the fiber sheet is a non-woven fabric.

8. The composite fiber-reinforced resin according to claim 1, wherein the natural fiber consists of cellulosic fiber and/or keratin-derived fiber.

9. The composite fiber-reinforced resin according to claim 1, wherein the fiber-reinforced composite material is a carbon fiber reinforced plastic (CFRP) prepreg.

10. The composite fiber-reinforced resin according to claim 1, which is a three-dimensional structure.

11. A shock absorber comprising the composite fiber-reinforced resin according to claim 1.
